(19) United States
(12) Patent Application Publication
(10) Pub. No.: US 2003/0198710 A1
(43) Pub. Date: Oct. 23, 2003

(54) Chewing gum base and chewing gum with ultra high molecular weight polyvinylacetate

(75) Inventors: Lasha A. Ross, Henderson, NV (US); Michael T. Bunczek, Lisle, IL (US)

Correspondence Address: WM. WRIGLEY JR. COMPANY, RESEARCH AND DEVELOPMENT, 3535 S. ASHLAND AVE., CHICAGO, IL, 60609, US

(73) Assignees: Mr.Jack Nimz, Chicago, IL; Wm. Wrigley Jr. Company, Chicago, IL (US)

(21) Appl. No.: 10/063,405

(22) Filed: Apr. 19, 2002

(51) Int. Cl. A23G 3/30

(52) U.S. Cl. 426/3

(57) ABSTRACT

A chewing gum base having ultra high molecular weight polyvinylacetate which is easily removable from indoor and outdoor surfaces. The ultra high molecular weight polyvinylacetate ranges from 100,000 to 600,000 daltons and increases the cohesion of the chewing gum base for easy removability.

### BACKGROUND OF INVENTION

The present invention relates to the composition of, and methods of producing a chewing gum base. More specifically, the present invention relates to chewing gum base compositions that produce gum base having reduced adhesion to indoor and outdoor surfaces as compared to typical chewing gum compositions.

When chewing gum is chewed, an insoluble portion remains. Although the remaining insoluble portion can be easily disposed of without creating any problems, when improperly disposed of, can create environmental issues. In this regard, the improper disposal of chewing gum, e.g. expectorating the chewing gum on a sidewalk, floor, or like area, can create a nuisance. Due to their typical formulations, chewing gums have an adhesive-like characteristic. Therefore, the chewed gum can stick to environmental surfaces onto which they are intentionally or unintentionally placed. Such environmental surfaces can include concrete, flooring materials, walls, fabric, carpeting, metal, wood, plastic, glass and other surfaces. This is very difficult to remove once it sticks and can be cause for great frustration. Used chewing gum cuds can also be unsightly when stuck to surfaces in public places. It is because of these circumstances that there is a consumer demand for an environmentally friendly chewing gum.

The present invention provides a chewing gum base containing an effective amount of an ultra high molecular weight polyvinylacetate to make an environmentally friendly chewing gum. It is known in the art of chewing gum making to include polyvinylacetate in chewing gum base for the purpose of making a non-adhesive chewing gum. U.S. Pat. No. 4,357,355 entitled Non-Stick Bubble Gum Base Composition claims the use of polyvinylacetate in bubble gum. The PVAc disclosed and claimed has a molecular weight less than or equal to 94,000 daltons. The present invention differs from U.S. Pat. No. 4,357,3 55 in that the molecular weights of the PVAc used are 100,000 dalton and greater.

### SUMMARY OF INVENTION

The present invention provides a gum base, and resulting chewing gum, that is environmentally friendly. As used herein, the term environmentally friendly refers to chewing gum compositions that can be easily removed from indoor or outdoor surfaces. A chewing gum cud, which is easily removable, is one which has a 50% or greater reduction in removal time and less than 20% by weight residue remaining on a surface to which it was stuck. Chewing gums which can be made from the chewing gum base of the present invention include chewing gums, bubble gums, and the like, of a variety of shapes and flavors standard in the art.

The present invention provides a chewing gum base containing an effective amount of an ultra high molecular weight polyvinylacetate to make an environmentally friendly chewing gum. The addition of ultra high molecular weight polyvinylacetate increases the cohesion of the chewing gum, preventing it from sticking to other surfaces and increasing the ease at with which it can be removed from other surfaces.

The present invention provides a gum base comprising and ultra high molecular weight polyvinylacetate (UHMW PVAc), a plasticizer, and a filler.

In an embodiment, the UHMW PVAc comprises approximately 20% to about 90% by weight of the gum base, the Plasticizer comprises approximately 15% to about 50% by weight of the gum base, and the filler comprises approximately 1% to about 30% by weight of the gum base.

In an embodiment, the gum base further comprises an emulsifier at a level up to about 60% by weight of the gum base.

### DETAILED DESCRIPTION

The present invention provides improved gum bases. Moreover, the present invention provides improved chewing gum made from the gum bases. The present invention provides a more environmentally friendly gum cud.

The present invention uses the UHMW PVAc to the advantage of increasing the cohesion in the chewing gum base to render it environmentally friendly by increasing its removability from surfaces other than the oral cavity.

The UHMW PVAc used in the present invention are of molecular weights ranging from 100,000 to 600,000 daltons. The UHMW PVAc used in the present invention are commercially available through Wacker Polymer Systems. The chewing gum base of the present invention also includes a plasticizer and a filler.

In an embodiment the UHMW PVAc molecular weight ranges from 150,000 to 300,000 daltons.

The UHMW PVAc may be used in an amount ranging from 1% to about 90% by weight of the chewing gum base. The plasticizer may be used in an amount ranging from 1% to about 60% by weight of the chewing gum base. The filler is present in an amount of about 1% to 60% by weight of the chewing gum base.

The UHMW PVAc may be used in an amount ranging from 15% to about 65% by weight of the chewing gum base. The plasticizer may be used in an amount ranging from 10% to about 50% by weight of the chewing gum base. The filler is present in an amount of about 1% to 30% by weight of the chewing gum base.

In an embodiment, the UHMW PVAc is present in an amount from 10% to 30% by weight of the chewing gum base.

In the present invention, an emulsifier may be present in an amount up to about 35% by weight of the chewing gum base.

In an embodiment of the invention there is 60% ultra high molecular weight polyvinylacetate, 35% plasticizer and 5% filler.

In an embodiment of the invention there is 60% ultra high molecular weight polyvinylacetate, 30% plasticizer, 5% emulsifier and 5% filler.

Plasticizers used in the present invention may include triacetin, medium chain triglyceride, mono- di- and triglycerides of fatty acids, glycerol ester of partially hydrogenated rosin, glycerol ester of polymerized rosin, glycerol ester of partially dimerized rosin, glycerol ester of rosin, glycerol ester of tall oil rosin, pentaerythritol esters of partially hydrogenated rosin, partially hydrogenated methyl esters of rosin, pentaerythritol ester of rosin, synthetic elastomer plasticizers, terpene resins derived from alpha-pinene, beta-pinene or d-limonene, triglycerides of non-hydrogenated, partially hydrogenated and fully hydrogenated cottonseed oil, soybean oil, palm oil, palm kernel oil, coconut oil, safflower oil, tallow oil, cocoa butter, unsaturated oils that contain, as one or more of their constituent groups, fatty acids of carbon chain length of from 6 to 1 8, monoglycerides, diglycerides, acetlylated monoglycerides, distilled mono- and di- glyercides and lecithin may, from their manufacturing processing, contain triglyceride levels less than 2 percent by weight. Mono- and diglycerides maybe considered as being of the same family as fats.

Preferred plasticizers include triacetin, acytylated mono- and di- and triglycerides of short chain fatty acids, acetlyated mono- and di- and triglycerides of medium chain fatty acids, acetylated monoglycerides of long chain fatty acids, methyl ester of rosin, low molecular weight PVAc. A preferred plasticizer will have a hydrophilicity similar to PVAc.

The chewing gum base of the present invention may further comprise a PVAc of molecular weight ranging from about 2,000 to about 99,000. The present invention may also further comprise a rubber. The rubber may be selected from the group consisting of polyisobutylene, butyl rubber, styrene butadiene, polyisoprene rubber, butadiene rubber and natural rubbers.

In an embodiment of the present invention further comprises a low molecular weight PVAc, ranging in molecular weight 2,000 to 20,000 daltons, is present in the amount up to about 50% by weight of the chewing gum base.

In an embodiment of the present invention further comprises a medium molecular weight PVAc, ranging in molecular weight 20,001 to 60,000 daltons, is present in the amount up to about 50% by weight of the chewing gum base.

In an embodiment of the present invention further comprises a high molecular weight PVAc, ranging in molecular weight 60,001 to 90,000 daltons, is present in the amount up to about 50% by weight of the chewing gum base.

Fillers used in the present invention may be selected from carbonate or precipitated carbonate types such as precipitated calcium carbonate, magnesium carbonate, calcium carbonate, ground limestone, magnesium silicate, aluminum silicate, clay alumina, talc, titanium oxide, mono-, di- and tricalcium phosphate, silica, ethyl cellulose, methyl cellulose, organic powders, polystyrene, polyethylene, oat fiber, wood fiber, apple fiber, zein, gluten, gliadin, casein and combinations thereof.

Emulsifiers, which also sometimes have plasticizing properties, used in the present invention may be selected from the following, glycerol mono and distearate, lecithin, mono and di-glycerides of fatty acids, triacetin, acetylated monoglyceride, polyglycerol esters, glycerol triacetate and carbohydrate polyesters, sucrose esters, sugar esters of fatty acids, sucrose stearate ester non-ionic surfactants or combinations thereof.

It is an advantage of the present invention to provide a more environmentally friendly chewing gum base and chewing gum. If cud is disposed of improperly, it is removable via a scraper. The present invention provides a firm chew, bulky cud with no tack to the teeth of the chewer and is easily processed. The gum base of the present invention is also hydrophilic and may be used as a delivery for an active agent or medicament. It has also been noted that when chewed, the present invention pulls debris off of the teeth of the chewer.

Chewing gum generally comprises a water soluble portion and a water insoluble portion. The water insoluble portion is referred to as the gum base.

Pursuant to the present invention, the water-insoluble portion of the gum typically may contain any combination of elastomers, vinyl polymers, elastomer plasticizers, softeners, waxes and other optional ingredients such as colorants and antioxidants.

The variety of gum base ingredients may be used provide the ability to modify the chewing characteristics of gums made from the gum base.

Elastomers provide the rubbery, cohesive nature to the gum which varies depending on this ingredient's chemical structure and how it is compounded with other ingredients. Elastomers suitable for use in the gum base and gum of the present invention include butadiene-styrene copolymers (SBR), isobutylene-isoprene copolymers (Butyl rubber), polybutadiene, polyisobutylene, and vinyl polymeric elastomers (polyvinyl acetate, polyethylene, vinyl acetate/vinyl laurate, vinyl acetate/vinyl stearate, ethylene/vinyl acetate) or mixtures thereof.

Other optional ingredients such as antioxidants may be used in gum base.

Antioxidants prolong shelf-life and storage of gum base, finished gum or their respective components, including fats and flavor oils. Antioxidants suitable for use in gum base or gum of the present invention include butylated hydroxyanisole (BHA), butylated hydroxytoluene (BHT), beta-carotenes, tocopherols, acidulants such as vitamin C, propyl gallate, and other synthetic and natural types, or mixtures thereof.

Preferably, the antioxidants used in the gum base are butylated hydroxyanisole (BHA), butylated hydroxytoluene (BHT), tocopherols, or mixtures thereof.

Waxes may be used in the gum base. Waxes aid in the solidification of gum bases and improving the shelf-life and texture. Wax crystal also improves the release of flavor. The smaller crystal size allows slower release of flavor since there is more hindrance of the flavor's escape from this wax versus a wax having larger crystal sizes.

Synthetic waxes are produced by means atypical of petroleum wax production and thus are not considered petroleum wax. These synthetic waxes may be used in accordance with the present invention and may be included optionally in the gum base and gum.

The synthetic waxes may include waxes containing branched alkanes and copolymerized with monomers such as, but not limited to, polypropylene and polyethylene and Fischer-Tropsch type waxes. Polyethylene wax is not in the same category as polyethylene, a polymer of ethylene monomers. Rather, polyethylene wax is a synthetic wax containing alkane units of varying lengths having attached thereto ethylene monomers.

Wax-free gum bases are specifically contemplated by the present invention. In these embodiments, wax is omitted and may be compensated for by using increased levels of fats and oils as is known in the prior art.

Elastomer plasticizers vary the firmness of the gum base. The plasticizers are glycerol ester of partially hydrogenated rosin, glycerol ester of polymerized rosin, glycerol ester of partially dimerized rosin, glycerol ester of rosin, glycerol ester of tall oil rosin, pentaerythritol esters of partially hydrogenated rosin, partially hydrogenated methyl esters of rosin, pentaerythritol ester of rosin, synthetic elastomer plasticizers such as terpene resins derived from alpha-pinene, beta-pinene and/or d-limonene and mixtures thereof.

Talc filler may be used in the gum base and gum of the present invention that may come in contact with or employ acid flavors or provide an acidic environment needed to prevent degradation of an artificial sweetener by reacting with calcium carbonate type fillers. Mean particle size for calcium carbonate and talc fillers typically range from about 0.1 micron to about 15 microns. More preferably, the optional fillers used have a mean preferably particle size range from about 0.4 to about 14 microns and are calcium carbonate and talc.

Flavorants and colorants impart characteristics or remove or mask undesired characteristics. Colorants may typically include FD&C type lakes, plant extracts, fruit and vegetable extracts and titanium dioxide. Flavorants may typically include cocoa powder, heat-modified amino acids and other vegetable extracts.

Gum bases are typically prepared by adding an amount of the elastomer and plasticizer to a heated sigma blade mixer with a front to rear speed ratio of about 1.2:1 to about 2:1, the higher ratio typically being used for chewing gum base which requires more rigorous compounding of its elastomers.

Compounding typically begins to be effective once the ingredients have massed together. Anywhere from 15 minutes to 90 minutes may be the length of compounding time. Preferably, the time of compounding is from 20 minutes to about 60 minutes. The amount of added plasticizer depends on the level of elastomer present. If too much elastomer plasticizer is added, the initial mass becomes over plasticized and not homogeneous.

Continuous processes using mixing extruders may also be used to prepare the gum base. After the initial ingredients have massed homogeneously and been compounded for the time desired, the balances of the base ingredients are added in a sequential manner until a completely homogeneous molten mass is attained.

Typically, any remainder of elastomer and plasticizer are added within approximately 60 minutes after the initial compounding time. The optional waxes and the oils are typically added after the elastomer and plasticizers and during the next 60 minutes.

Then the mass is allowed to become homogeneous before discharging.

U.S. Pat. NO. 6,238,710, herein incorporated by reference, claims a method for continuous chewing gum base manufacturing. The method entails compounding all ingredients in a single extruder. U.S. Pat. No. 6,086,925 discloses the manufacture of chewing gum base by adding a hard elastomer, a filler and a lubricating agent to a continuous mixer. U.S. Pat. No. 6,01 7,565, herein incorporated by reference, discloses a continuous manufacture process which automatically and continuously feeds ingredients into an apparatus, mixes, and discharges the desired end product. The end product is automatically dusted, rolled scored and wrapped.

Typical base batch processing times may vary from about one to about three hours, preferably from about 1.5 to 2.5 hours, depending on the formulation. The final mass temperature when discharged may be between 50° C. and 130° C. and preferably between 70° C. and 120° C. The completed molten mass is emptied from the mixing kettle into coated or lined pans, extruded or cast into any desirable shape and allowed to cool and solidify. Those skilled in the art will recognize that many variations of the above described procedure may be followed.

In the alternative continuous process, ingredients are added continuously at various points along the length of the extruder. In this case, the transmit time through the extruder would be substantially less than an hour.

The water-soluble portion of the chewing gum may comprise softeners, sweeteners, flavoring agents and combinations thereof. The sweeteners often fill the role of bulking agents in the gum. The bulking agents generally comprise from approximately 5 percent to about 90 percent, preferably from approximately 20 percent to about 80 percent.

Softeners are added to the chewing gum in order to optimize the chewability and mouth feel of the gum. Softeners typically constitute from approximately 0.5 percent to about 25.0 percent by weight of the chewing gum. Softeners contemplated for use in the gum include glycerin, lecithin and combinations thereof. Further, aqueous sweetener solutions such as those containing sorbitol, hydrogenated starch hydrolysates, corn syrup and combinations thereof may be used as softeners and bulking agents in gum. Sugar-free formulations are also typical.

Sugar sweeteners generally include saccharide-containing components commonly known in the chewing gum art which comprise, but are not limited to, sucrose, dextrose, maltose, dextrin, dried invert sugar, fructose, levulose, galactose, corn syrup solids and the like, alone or in any combination.

The present invention can also be used in combination with sugarless sweeteners. Generally, sugarless sweeteners include components with sweetening characteristics but which are devoid of the commonly known sugars and comprise, but are not limited to, sugar alcohols such as sorbitol, mannitol, xylitol, hydrogenated starch hydrolysates, maltitol and the like, alone or in any combination.

A flavoring agent may be present in the chewing gum in an amount within the range of from approximately 0.1 to about 10.0 weight percent, and preferably from approximately 0.5 to about 3.0 weight percent of the gum. The flavoring agents may comprise essential oils, synthetic flavors, or mixtures thereof including, but not limited to, oils derived from plants and fruits such as citrus oils, fruit essences, peppermint oil, spearmint oil, close oil, oil of wintergreen, anise and the like. Artificial flavoring components are also contemplated for use in gums of the present invention. Those skilled in the art will recognize that natural and artificial flavoring agents may be combined in any sensory acceptable blend. All such flavors and flavor blends are contemplated for use in gums of the present invention.

Optional ingredients such as colors, emulsifiers and pharmaceutical agents may be added to the chewing gum.

In general, chewing gum is manufactured by sequentially adding the various chewing gum ingredients to a commercially available mixer known in the art. After the initial ingredients have been thoroughly mixed, the gum mass is discharged from the mixer and shaped into the desired form such as by rolling into sheets and cutting into sticks, extruded into chunks or casting into pellets.

Generally, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent/sweetener.

Further portions of the bulking agent/sweetener may then be added to the mixer. A flavoring agent is typically added with the final portion of the bulking agent/sweetener. A high-intensity sweetener is preferably added after the final portion of bulking agent and flavor have been added.

The entire mixing procedure typically takes from five to fifteen minutes, but longer mixing times may sometimes be required. Those skilled in the art will recognize that many variations of the above described procedure may be followed. Again, one specifically contemplated embodiment is the use of an extruding mixer for continuous processing. In such a process, ingredients are added continuously at various points along the length of the extruder while homogeneously mixed gum continuously issues from the discharge end of the extruder.

The following tables shows examples of formulas as possible embodiments of the present invention. The present invention is not limited to the following formulas.

Specific components use in the present invention are as follows. Percentages are by weight of the chewing gum base. Example 1, the UHMW PVAc used were 30% Wacker UW4 and 30% Wacker B100, the Plasticizers used 25% triacetin and 10% medium chain triglyceride and the filler is calcium carbonate at 5%. In Example 2 the UHMW PVAc used were 10% Wacker UW4, 20% Wacker B100, and 30% Wacker Linac. The Plasticizers used 25% triacetin and 10% medium chain triglyceride and the filler is calcium carbonate at 5%, a fat is 5% monoglyceride and the emulsifier is 5% sucrose stearate ester.

TABLE 1
Example Formulas of Gum Base by % Weight

| | Ex. 1 | Ex. 2 | Ex. 3 | Ex. 4 | Ex. 5 | Ex. 6 |
|---|---|---|---|---|---|---|
| UHMW PVAc | 60 | 60 | 65 | 60 | 68 | 60 |
| Plasticizer | 35 | 30 | 25 | 30 | 27 | 35 |
| Filler | 5 | 5 | 5 | 5 | 5 | 5 |
| Emulsifier | — | 5 | 5 | 5 | — | — |
| Total Percent | 100 | 100 | 100 | 100 | 100 | 100 |

TABLE 2
Example Formulas of Gum Base by % Weight cont.

| | Ex. 7 | Ex. 8 | Ex. 9 | Ex. 10 | Ex. 11 | Ex. 12 |
|---|---|---|---|---|---|---|
| UHMW PVAc | 22 | 10 | 20 | 7 | 18 | 15 |
| Low PVAc | 18 | 11 | 5 | 27 | 15 | 5 |
| Medium PVAc | 10 | 30 | 20 | — | 20 | 10 |
| High PVAc | — | — | 20 | 20 | 12 | 30 |
| Plasticizer | 43 | 29 | 18 | 26 | 27 | 35 |
| Filler | 7 | 10 | 4 | 5 | 8 | 5 |
| Emulsifier | — | 10 | 13 | 15 | — | — |
| Total Percent | 100 | 100 | 100 | 100 | 100 | 100 |

Example 3 and Example 4 were tested against a control in a removability study. The control used in this study was U.K. Extra Peppermint, which is commercially available. A chewed cud was stuck and indoor surface and an outdoor surface. A Tenant scrubber with nylon brushes and a rubber scraper was used to determine the removability of the chewed cuds. The smooth indoor surface had 100% removability for both Example 3 and Example 4. The outdoor surface had 100% removability with Example 3 and about 30% with Example 4. These results are due to the increased cohesion of the chewing gum base when the ultra high molecular weight PVAc is added to the formulation.

TABLE 3
Results of Removability Study

| Scraper | % Removed From Indoor | % Removed From Outdoor |
|---|---|---|
| Test | Smooth Surface | Rough Surface |
| Control | 10 | 10 |
| Example 3 | 100 | 100 |
| Example 4 | 100 | 30 |

1. A chewing gum base comprising:
a) ultra high molecular weight polyvinylacetate with molecular weight ranging between about 100,000 and about 600,000 daltons;
b) a plasticizer;
c) and a filler.

2. The chewing gum base of claim 1 wherein said plasticizer is selected from the group consisting of triacetin, acytylated mono- and di- and triglycerides of short chain fatty acids, acetlyated mono- and di- and triglycerides of medium chain fatty acids, acetylated monoglycerides of long chain fatty acids, methyl ester of rosin, low molecular weight PVAc and combinations therof.

3. The chewing gum base of claim 1 wherein said ultra high molecular weight polyvinylacetate is present in the amount ranging from 1% to about 90% by weight of the gum base.

4. The chewing gum base of claim 1 wherein said plasticizer is present in an amount ranging from 1% to about 60% by weight of said gum base.

5. The chewing gum base of claim 1 wherein said filler is selected from the group consisting of precipitated calcium carbonate, magnesium carbonate, calcium carbonate, ground limestone, magnesium silicate, aluminum silicate, clay alumina, talc, titanium oxide, mono-, di- and tricalcium phosphate, silica, ethyl cellulose, methyl cellulose, organic powders, polystyrene, polyethylene, oat fiber, wood fiber, apple fiber, zein, gluten, gliadin, casein and combinations thereof.

6. The chewing gum base of claim 1 wherein said filler is present in an amount ranging from 1% to about 60% by weight of said gum base.

7. The chewing gum base of claim 1 wherein said plasticizer is selected from the group consisting of triglycerides of non-hydrogenated, partially hydrogenated and fully hydrogenated cottonseed oil, soybean oil, palm oil, palm kernel oil, coconut oil, safflower oil, tallow oil, cocoa butter, medium chained triglycerides, unsaturated oils, monoglycerides, diglycerides, acetylated monoglycerides, distilled mono- and di- glycerides and combinations thereof.

8. The chewing gum base of claim 1 wherein said chewing gum base further comprises an emulsifier.

9. The chewing gum composition of claim 8 wherein said emulsifier is present in an amount up to about 60% by weight of said chewing gum base.

10. The chewing gum base of claim 8 wherein said emulsifier is selected from the group consisting of glycerol mono and distearate, lecithin, mono and di-glycerides of fatty acids, triacetin, acetylated monoglyceride, polyglycerol esters, glycerol triacetate and carbohydrate polyesters, sucrose esters, sugar fatty acid ester, sucrose stearate ester non-ionic surfactants or combinations thereof.

11. The chewing gum base of claim 8 wherein said emulsifier is selected from the group consisting of sucrose esters, sugar fatty acid ester, sucrose stearate ester and combinations thereof.

12. The chewing gum base of claim 1 wherein said chewing gum base further comprises a polyvinylacetate of a molecular weight ranging from about 2,000 to 99,000 daltons.

13. The chewing gum base of claim 1 wherein said ultra high molecular weight polyvinylacetate is present in the amount of 15%-65% by weight of said chewing gum base.

14. The chewing gum base of claim 1 wherein said ultra high molecular weight polyvinylacetate is present in the amount of 10%-30% by weight of said chewing gum base.

15. The chewing gum base of claim 1 wherein said plasticizer is present in an amount the amount of 10%-50% by weight of said chewing gum base.

16. The chewing gum base of claim 1 wherein said filler is present in the amount of 1%-30% by weight of said chewing gum base.

17. The chewing gum base of claim 1 wherein said chewing gum base further comprises a low molecular weight PVAc ranging from 2,000 to 20,000 daltons.

18. The chewing gum base of claim 17 wherein said low molecular weight PVAc is present in an amount up to about 50% by weight of said chewing gum base.

19. The chewing gum base of claim 1 wherein said chewing gum base further comprises a medium molecular weight PVAc ranging from 20,001 to 60,000 daltons.

20. The chewing gum base of claim 19 wherein said medium molecular weight PVAc is present in an amount up to about 50% by weight of said chewing gum base.

21. The chewing gum base of claim 1 wherein said chewing gum base further comprises a high molecular weight PVAc ranging from 60,001 to 90,000 daltons.

22. The chewing gum base of claim 21 wherein said high molecular weight PVAc is present in an amount up to about 500% by weight of said chewing gum base.

23. A chewing gum composition made of flavor, sweetener and a chewing gum base comprising:
a) ultra high molecular weight polyvinylacetate with molecular weight ranging between about 100,000 and about 600,000 daltons;
b) a plasticizer;
c) and a filler.

24. The chewing gum composition of claim 23 wherein said plasticizer is selected from the group consisting of triacetin, acytylated mono- and di- and triglycerides of short chain fatty acids, acetlyated mono- and di- and triglycerides of medium chain fatty acids, acetylated monoglycerides of long chain fatty acids, methyl ester of rosin, low molecular weight PVAc and combinations therof.

25. The chewing gum composition of claim 23 wherein said ultra high molecular weight polyvinylacetate is present in the amount ranging from 1% to about 90% by weight of the gum base.

26. The chewing gum composition of claim 23 wherein said plasticizer is present in an amount ranging from 1% to about 60% by weight of said gum base.

27. The chewing gum composition of claim 23 wherein said filler is selected from the group consisting of precipitated calcium carbonate, magnesium carbonate, calcium carbonate, ground limestone, magnesium silicate, aluminum silicate, clay alumina, talc, titanium oxide, mono-, di- and tricalcium phosphate, silica, ethyl cellulose, methyl cellulose, organic powders, polystyrene, polyethylene, oat fiber, wood fiber, apple fiber, zein, gluten, gliadin, casein and combinations thereof.

28. The chewing gum composition of claim 23 wherein said filler is present in an amount ranging from 1% to about 60% by weight of said gum base.

29. The chewing gum composition of claim 23 wherein said plasticizer is selected from the group consisting of triglycerides of non-hydrogenated, partially hydrogenated and fully hydrogenated cottonseed oil, soybean oil, palm oil, palm kernel oil, coconut oil, safflower oil, tallow oil, cocoa butter, medium chained triglycerides, unsaturated oils, monoglycerides, diglycerides, acetylated monoglycerides, distilled mono- and di- glycerides and lecithin and combinations thereof.

30. The chewing gum composition of claim 23 wherein said chewing gum base contains an emulsifier.

31. The chewing gum composition of claim 30 wherein said emulsifier is present in an amount up to about 60% by weight of said chewing gum base.

32. The chewing gum composition of claim 30 wherein said emulsifier is selected from the group consisting of glycerol mono and distearate, lecithin, mono and di-glycerides of fatty acids, triacetin, acetylated monoglyceride, polyglycerol esters, glycerol triacetate and carbohydrate polyesters, sucrose esters, sugar esters of fatty acids, sucrose stearate ester, non-ionic surfactants or combinations thereof.

33. The chewing gum base of claim 30 wherein said emulsifier is selected from the group consisting of sucrose esters, sugar fatty acid ester, sucrose stearate ester and combinations thereof.

34. The chewing gum composition of claim 23 wherein said chewing gum base further comprises a polyvinylacetate of a molecular weight ranging from about 2,000 to 99,000 daltons.

35. The chewing gum composition of claim 23 wherein said ultra high molecular weight polyvinylacetate is present in the amount of 15%-65% by weight of said chewing gum base.

36. The chewing gum composition of claim 23 wherein said ultra high molecular weight polyvinylacetate is present in the amount of 10%-30% by weight of said chewing gum base.

37. The chewing gum composition of claim 23 wherein said plasticizer is present in the amount of 10%-50% by weight of said chewing gum base.

38. The chewing gum composition of claim 23 wherein said filler is present in the amount of 1%-30% by weight of said chewing gum base.

39. The chewing gum composition of claim 23 wherein said chewing gum base further comprises a low molecular weight PVAc ranging from 2,000 to 20,000 daltons.

40. The chewing gum composition of claim 39 wherein said low molecular weight PVAc is present in an amount up to about 50% by weight of said chewing gum base.

41. The chewing gum composition of claim 23 wherein said chewing gum base further comprises a medium molecular weight PVAc ranging from 20,001 to 60,000 daltons.

42. The chewing gum composition of claim 41 wherein said medium molecular weight PVAc is present in an amount up to about 50% by weight of said chewing gum base.

43. The chewing gum composition of claim 23 wherein said chewing gum base further comprises a high molecular weight PVAc ranging from 60,001 to 90,000 daltons.

44. The chewing gum composition of claim 43 wherein said high molecular weight PVAc is present in an amount up to about 50% by weight of said chewing gum base.

45. The chewing gum composition of claim 23 wherein after being chewed a chewing gum cud remains which is easily removable from indoor and outdoor surfaces.

46. A chewing gum base comprising:
a) ultra high molecular weight polyvinylacetate with molecular weight ranging between about 150,000 to about 300,000 daltons;
b) a plasticizer;
c) and a filler.
